(19) United States
(12) Patent Application Publication
(10) Pub. No.: US 2019/0320149 A1
(43) Pub. Date: Oct. 17, 2019

(54) LIGHT SOURCE DEVICE, ILLUMINATION APPARATUS, AND PROJECTOR APPARATUS

(71) Applicant: SHARP KABUSHIKI KAISHA, Osaka (JP)

(72) Inventors: KOJI TAKAHASHI, Sakai City (JP); HIDENORI KAWANISHI, Sakai City (JP)

(21) Appl. No.: 16/379,510

(22) Filed: Apr. 9, 2019

(30) Foreign Application Priority Data
Apr. 12, 2018 (JP) 2018-076973

(51) Int. Cl. H04N 9/31; G03B 21/20

(52) U.S. Cl. CPC H04N 9/3161; H04N 9/3164; G03B 21/208; G03B 21/2066; G03B 21/2033

(57) ABSTRACT

A light source device includes an optical member. The optical member has an inner space. At least one entrance opening and one exit opening are formed in the optical member. The at least one entrance opening allows a laser beam emitted from a laser-beam source to enter the inner space. The one exit opening allows a laser beam that is scattered or reflected in the inner space to be emitted to the outside of the optical member.

### BACKGROUND

### 1. Field

The present disclosure relates to a light source device, an illumination apparatus, and a projector apparatus.

### 2. Description of the Related Art

In recent years, there have been developed technologies related to a projector apparatus that mixes light beams from a plurality of visible-light semiconductor lasers or infrared semiconductor lasers and emits mixed laser beams. For example, there has been developed a laser-scan projector that collimates and mixes light beams in three colors, which are R, G, and B, or light beams in R, G, and B colors plus an infrared light beam. The laser-scan projector superposes the light paths of these light beams, emits the light beams, and projects an image by using a scanning device such as a MEMS. Such a projector utilizes technology for precisely aligning and fixing lenses, mirrors, and the like so that the projector can superpose light beams having different wavelengths for R, G, and B without displacement. Examples of known technologies for mixing a plurality of laser beams having different wavelengths for R, G, B, and the like include a technology of superposing a plurality of collimated laser beams via a dichroic mirror and the like. For example, Japanese Unexamined Patent Application Publication (Translation of PCT Application) No. 2008-529069 (published on Jul. 31, 2008) discloses, in FIG. 3 and paragraphs [0016] to [0020] thereof, a device in which a red laser 22, a blue laser 28, and a green laser 34 are “collinearly” arranged via dichroic mirrors 52 and 54.

It is desirable to provide a light source device that can be manufactured without performing precise optical alignment and that can mix light beams from a plurality of light sources with a simple structure.

### SUMMARY

According to an aspect of the disclosure, there is provided a light source device includes an optical member. The optical member has an inner space. At least one entrance opening and one exit opening are formed in the optical member. The at least one entrance opening allows a laser beam emitted from a laser-beam source to enter the inner space. The one exit opening allows a laser beam that is scattered or reflected in the inner space to be emitted to the outside of the optical member.

With the aspect of the present disclosure, it is possible to provide a light source device that can be manufactured without performing precise optical alignment and that can mix light beams from a plurality of light sources with a simple structure.

### BRIEF DESCRIPTION OF THE DRAWINGS

FIG. 1A is a perspective view illustrating a part of the structure of a light source device according to a first embodiment of the present disclosure, FIG. 1B is a side sectional view illustrating a part of the structure of the light source device taken along line IB-IB in FIG. 1A, and FIG. 1C is a top view illustrating a part of the structure of the light source device;

FIG. 2 is a side sectional view illustrating a part of the structure of the light source device according to the first embodiment of the present disclosure, a laser device, and the path of a laser beam;

FIG. 3 is a perspective view illustrating a part of the structure of the light source device according to the first embodiment of the present disclosure, laser devices, and the paths of laser beams;

FIG. 4 is a side sectional view illustrating a part of the structure of the light source device according to the first embodiment of the present disclosure;

FIGS. 5A and 5B are side sectional views each illustrating a part of the structure of the light source device according to the first embodiment of the present disclosure and the path of an emitted light beam;

FIG. 6A is a side sectional view illustrating a part of the structure of a light source device according to a second embodiment of the present disclosure, and FIG. 6B is a top view illustrating a part of the structure of the light source device;

FIG. 7A is a perspective view illustrating a part of the structure of a light source device according to a third embodiment of the present disclosure, and FIG. 7B is a side sectional view illustrating a part of the structure of the light source device;

FIG. 8 is a side sectional view illustrating a part of the structure of the light source device according to the third embodiment of the present disclosure, a laser device, and the path of a laser beam;

FIG. 9 is a side sectional view illustrating a part of the structure of a light source device according to a fourth embodiment of the present disclosure;

FIG. 10A is a perspective view illustrating a part of the structure of a light source device according to a fifth embodiment of the present disclosure, and FIG. 10B is a side sectional view illustrating a part of the structure of the light source device;

FIG. 11 is a side sectional view illustrating a part of the structure of the light source device according to the fifth embodiment of the present disclosure, laser devices, and the paths of laser beams;

FIG. 12A is a perspective view illustrating a part of the structure of a light source device according to a sixth embodiment of the present disclosure, and FIG. 12B is a side sectional illustrating a part of the structure of the light source device;

FIG. 13 is a side sectional view illustrating a part of the structure of the light source device according to the sixth embodiment of the present disclosure, laser devices, and the paths of laser beams; and

FIGS. 14A and 14B are side sectional views each illustrating a part of the structure of the light source device according to the sixth embodiment of the present disclosure, laser devices, and the paths of laser beams.

### DESCRIPTION OF THE EMBODIMENTS

### First Embodiment

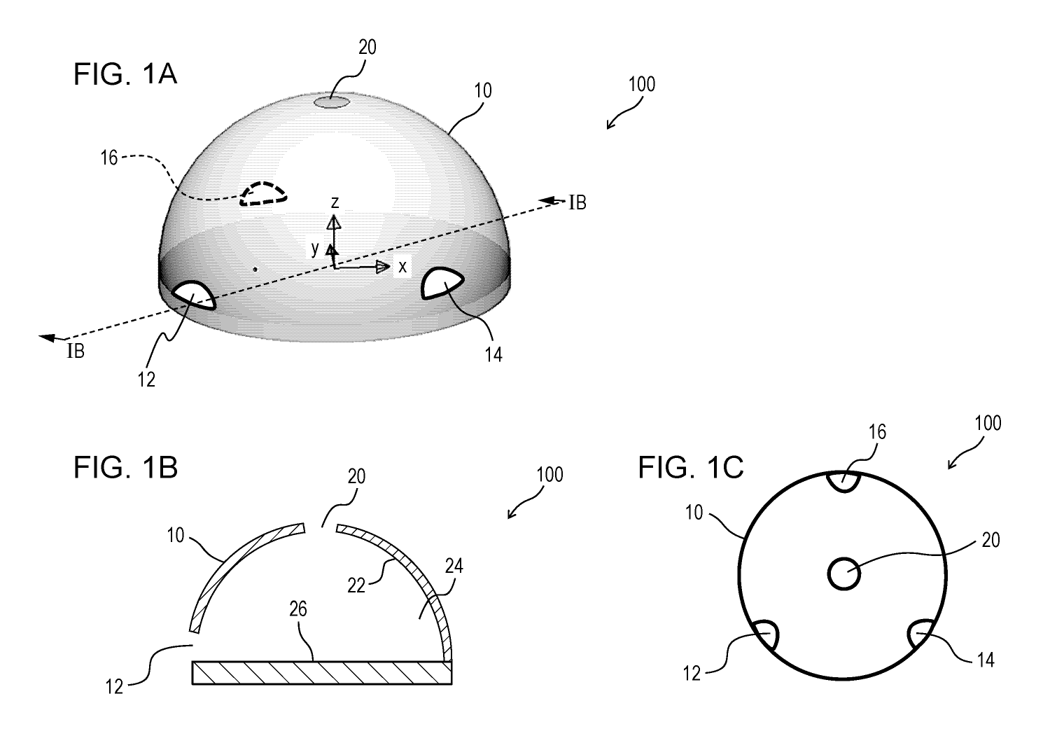

Referring to FIGS. 1A to 5B, a first embodiment of the present disclosure will be described in detail.

FIG. 1A is a perspective view illustrating a part of the structure of a light source device 100 according to the present embodiment. FIG. 1B is a side sectional view illustrating a part of the structure of the light source device 100. FIG. 1C is a top view illustrating a part of the light source device 100. As illustrated in FIGS. 1A to 1C, the light source device 100 includes an optical member 10, and an inner space 24 is formed in the optical member 10. Entrance openings 12, 14, and 16, which allow laser beams emitted from laser-beam sources to enter the inner space 24, and one exit opening 20, which allows laser beams that are scattered or reflected in the inner space 24 to be emitted to the outside, are formed in the optical member 10. With the above structure, light beams emitted from a plurality of light sources and entered the optical member can be uniformly mixed and emitted to the outside of the optical member.

An inner wall 22 and a bottom surface 26, which define the boundary of the inner space 24, are coated with a light diffusing substance. With the above structure, light beams entered the inner space are diffused in the inner space, and the light beams are uniformly mixed. The light diffusing substance is not particularly limited, provided that the substance is a light scattering material having high reflectivity. Examples of the light diffusing substance include barium sulfate, titanium oxide, and zinc oxide.

In the present embodiment, the shape of the inner wall is, for example, hemispherical. The shape of the bottom surface 26 of the optical member is, for example, a circle having a diameter of 5 mm. With the above structure, light beams emitted from a plurality of light sources can be uniformly mixed and emitted to the outside of the optical member.

In the present embodiment, the inner space 24 is not filled with anything and is hollow. With the above structure, because light beams entered the optical member are not absorbed by a filler in the optical member, the light beams can be efficiently emitted to the outside of the optical member.

In the present embodiment, the three entrance openings 12, 14, and 16 are formed along the edge of the bottom surface 26 of the hemispherical inner wall; and the exit opening is formed at the vertex of the hemisphere. The three entrance openings and the exit opening may be formed so as to be positioned relative to each other in such a way that, when one of the entrance openings is connected by a straight line with the center of the circle of the bottom surface, any of the other entrance openings and the exit opening is located so as to avoid an extension line of the straight line. In other words, the entrance openings and the exit opening may be formed in such a way that, when one of the entrance openings is connected by a straight line with the center of the circle of the bottom surface 26 of the hemispherical inner wall, any of the other entrance openings and the exit opening does not overlap an extension line of the straight line.

With the above structure, leakage of a laser beam entered from an entrance opening to the outside of the optical member from another entrance opening or the exit opening can be suppressed.

The exit opening may be formed at a position from which a laser beam that has been at least once reflected by the inner wall of the optical member is emitted to the outside.

With the above structure, laser beams emitted from a plurality of light sources can be uniformly mixed in the inner space of the optical member and emitted to the outside of the optical member.

In the present embodiment, the opening diameters of the entrance openings and the exit opening are not particularly limited, provided that these openings allow entry and emission of laser beams. The opening diameters of the entrance openings and the exit opening may be appropriately determined in accordance with the areas of light emitting points of laser-beam sources and the area to be irradiated with laser beams emitted from the exit opening. In view of suppressing leakage of light from the inside of the optical member, the opening diameters of the entrance openings may be in the range of 0.1 mm to 1 mm and the opening diameter of the exit opening may be in the range of 0.5 mm to 2 mm.

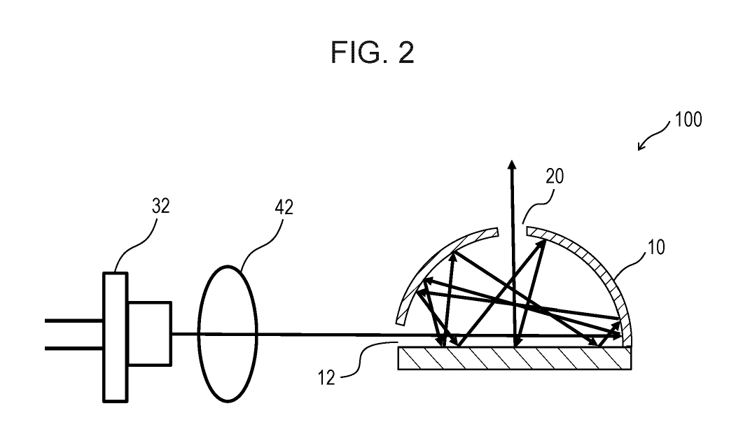

FIG. 2 is a side sectional view illustrating a part of the structure of the light source device 100 according to the present embodiment, a laser device, and the path of a laser beam. As illustrated in FIG. 2, in the present embodiment, the light source device 100 includes a collimating lens 42. The collimating lens 42 changes a divergent light beam emitted from an external laser-beam source into a collimated beam and causes the collimated beam to enter the entrance opening 12. When the light source device includes the collimating lens, the light source device can control the width of a light beam from the laser-beam source and allows the light beam to enter the optical member efficiently.

For example, a semiconductor laser is used as an external light source. In FIG. 2, a laser beam emitted from a red semiconductor laser device 32 passes through the collimating lens 42, enters the optical member 10 from the entrance opening 12, is reflected a plurality of times by the inner wall, and then is emitted from the exit opening 20. The type of the light source is not particularly limited. Examples of the light source include a semiconductor laser, a dye laser, a solid-state laser, and an excimer laser. In view of reduction in size, the light source may be a semiconductor laser.

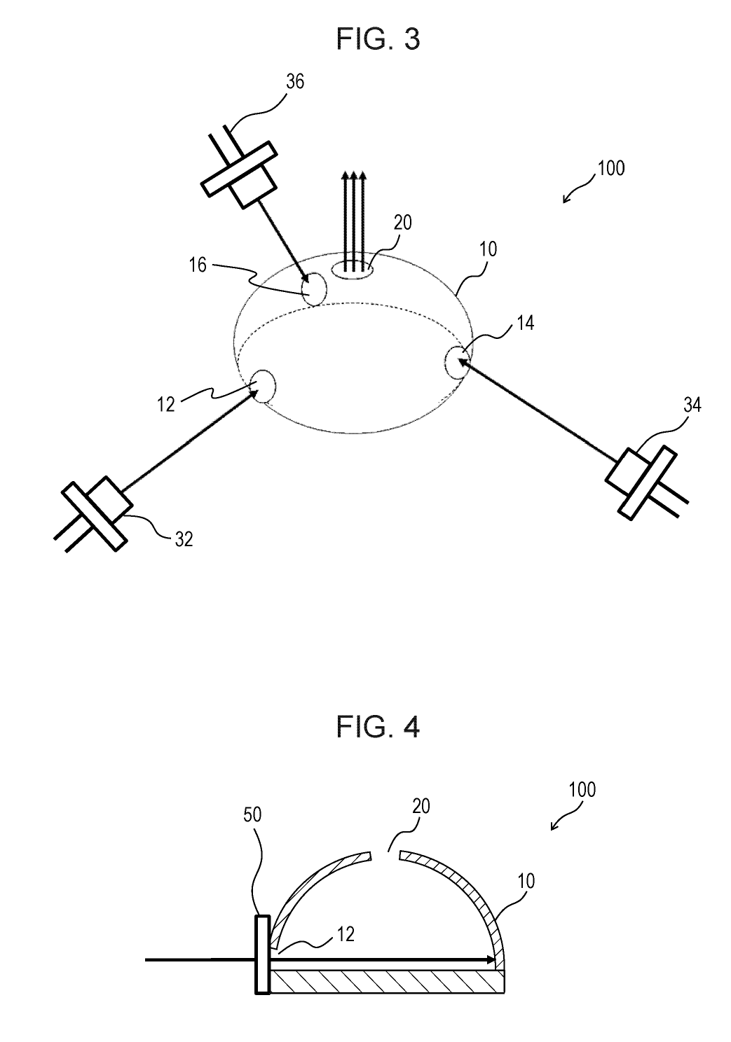

FIG. 3 is a perspective view illustrating a part of the structure of the light source device 100, laser devices, and the paths of laser beams. As illustrated in FIG. 3, in the present embodiment, laser beams that are emitted from semiconductor laser-beam sources and that have different wavelengths enter through three entrance openings. For example, a red laser beam from the red semiconductor laser device 32 enters through the entrance opening 12, a blue (B) laser beam from a blue semiconductor laser device 34 enters through the entrance opening 14, and a green laser beam from a green semiconductor laser device 36 enters through the entrance opening 16. With the above structure, a white light beam in which R, G, and B laser beams are uniformly mixed can be obtained. Which laser beams emitted from which semiconductor laser devices enter through which entrance openings is not particularly limited.

In the present embodiment, laser beams having wavelengths corresponding to R, G, and B are emitted from three laser-beam sources and enter through three entrance openings. However, the number of entrance openings is not particularly limited. For example, the number of entrance openings may be one, two, four, or more. One entrance opening may allow only one laser beam to enter, or one entrance opening may allow laser beams having different wavelengths and emitted from two or more laser-beam sources to enter. For example, when allowing laser beams having different wavelengths to enter, it is more desirable to allow each of the laser beams to enter through a corresponding one of two or more entrance openings than through one entrance opening. This is because, when light beams enter through different entrance openings, the light beams are diffused and reflected along different light paths and more uniformly mixed.

In the present embodiment, R, G, and B laser beams enter through the entrance openings, and a white light beam is emitted from the exit opening. However, the types of the entering light beams and the emitted light beam are not limited to these. For example, in accordance with the use of the light source device, a monochrome light beam or a non-white light beam having a plurality of spectra may be emitted. The entering light beams and the emitted light beam are not limited to visible light beams. An infrared light beam or an ultraviolet light beam may enter through an entrance opening, and a light beam in which the infrared light beam or the ultraviolet light beam are mixed may be emitted from the exit opening.

FIG. 4 is a side sectional view illustrating a part of the structure of the light source device 100 according to the present embodiment. As illustrated in FIG. 4, for example, a filter 50 may be disposed at each entrance opening. The filter 50 transmits the wavelength of a laser beam to enter through the entrance opening and does not transmit the other wavelengths. Examples of the filter 50 include a band-pass filter. With the above structure, only a laser beam emitted from a laser-beam source to enter the optical member is transmitted, and the other laser beams, such as a laser beam entered from another entrance opening and having a different wavelength, is not transmitted. Therefore, leakage of a laser beam to the outside of the optical member can be suppressed.

The filter 50 may be a polarizing filter such as a wire-grid polarizing filter. For example, in order to allow only a linearly polarized light beam polarized in a specific direction to enter the optical member, a polarizing filter may be disposed so as to transmit only the polarized light beam polarized in the specific direction. With the above structure, while a laser beam emitted from a laser-beam source enters the optical member, only a polarized light beam whose polarization direction coincides with the polarization direction of the polarizing filter can exit through the entrance opening. Therefore, it is possible to reduce the probability of leakage of a light beam from the inside of the optical member through the entrance opening.

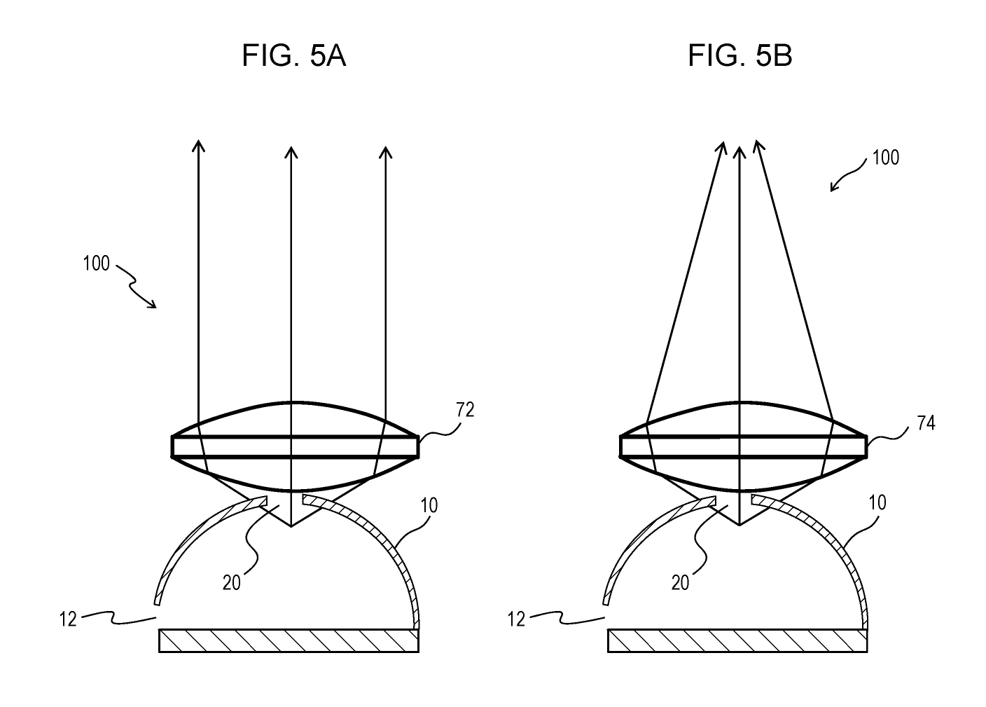

FIGS. 5A and 5B are side sectional views each illustrating a part of the structure of the light source device 100 according to the present embodiment and the path of an emitted light beam. As an example of the present embodiment, the light source device 100 further includes a light projecting portion 72 or 74 that controls a laser beam emitted to the outside of the exit opening. With the above structure, light beams emitted from a plurality of light sources and entered the optical member can be uniformly mixed and emitted to the outside of the optical member, and the area to be irradiated with light beams emitted from the exit opening can be adjusted.

FIG. 5A illustrates the light projecting portion 72 that is a convex lens disposed outside the exit opening 20, in a state in which the convex lens changes an emitted laser beam into a collimated beam. FIG. 5B illustrates the light projecting portion 74 that is a convex lens disposed outside the exit opening 20, in a state in which the convex lens changes an emitted laser beam into a convergent beam. Examples of the light projecting portion include, in addition to a convex lens, a lens such as a concave lens or a Fresnel lens, and a reflector such as a concave mirror or a convex mirror. A lens for controlling a laser beam may be appropriately selected in accordance with the use of an emitted laser beam. With the above structure, the area to be irradiated with a white light beam emitted from the exit opening can be adjusted.

### Second Embodiment

A second embodiment of the present disclosure will be described. For convenience of description, descriptions of members that have the same functions as those of the first embodiment will be omitted.

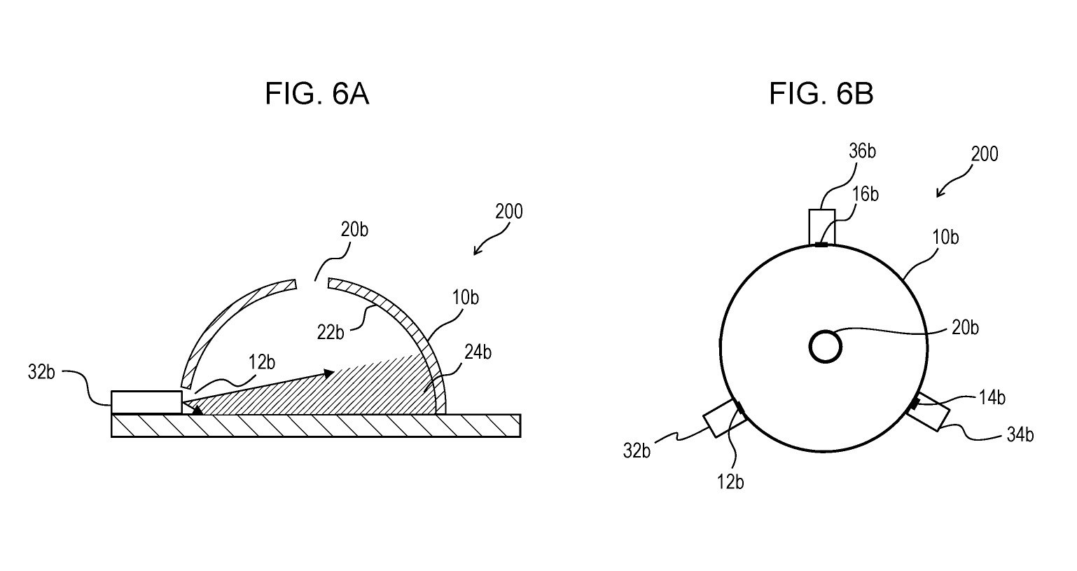

FIG. 6A is a side sectional view illustrating a part of the structure of a light source device 200 according to the present embodiment. FIG. 6B is a top view illustrating a part of the structure of the light source device 200. As illustrated in FIGS. 6A and 6B, the light source device 200 includes an optical member 10b, and an inner space 24b is formed in the optical member 10b. Entrance openings 12b, 14b, and 16b and one exit opening 20b are formed in the optical member 10b. Laser beams enter through the respective entrance openings, and the laser beams are scattered or reflected in the inner space 24b and emitted from the exit opening 20b. With the above structure, light beams emitted from a plurality of light sources and entered the optical member can be uniformly mixed and emitted to the outside of the optical member.

In the present embodiment, the structures and the operational effects of an inner wall 22b and the inner space 24b are the same as those of the first embodiment.

In the present embodiment, the light source device 200 further includes a red semiconductor laser device 32b, a blue semiconductor laser device 34b, and a green semiconductor laser device 36b. With the above structure, a white light beam in which R, G, and B laser beams are uniformly mixed can be obtained.

As an example of the present embodiment, each of the semiconductor laser devices is disposed at a corresponding one of the three entrance openings. For example, the red semiconductor laser device 32b is disposed at the entrance opening 12b, the blue semiconductor laser device 34b is disposed at the entrance opening 14b, and the green semiconductor laser device 36b is disposed at the entrance opening 16b. Which laser beams emitted from which semiconductor laser devices enter through which entrance openings is not particularly limited.

When the light source device includes semiconductor laser devices, the light source device has high portability, because the optical member and the laser devices are integrated with each other and the size of the entirety of the light source device can be reduced. Moreover, because alignment of lenses and the like is not necessary, the light source device has high vibration resistance and high impact resistance. In particular, the size of the light source device can be further reduced by mounting the semiconductor laser devices in the form of bare chips.

In the present embodiment, the light source device 200 does not have a lens between the laser device and the entrance opening, and the laser device is in contact with the entrance opening. With the above structure, a laser beam enters the optical member while spreading at a fixed angle and is diffused in the optical member. Therefore, even when a plurality of laser beams having different wavelengths are reflected only a small number of times by the inner wall of the optical member, the laser beams can be uniformly mixed easily.

### Third Embodiment

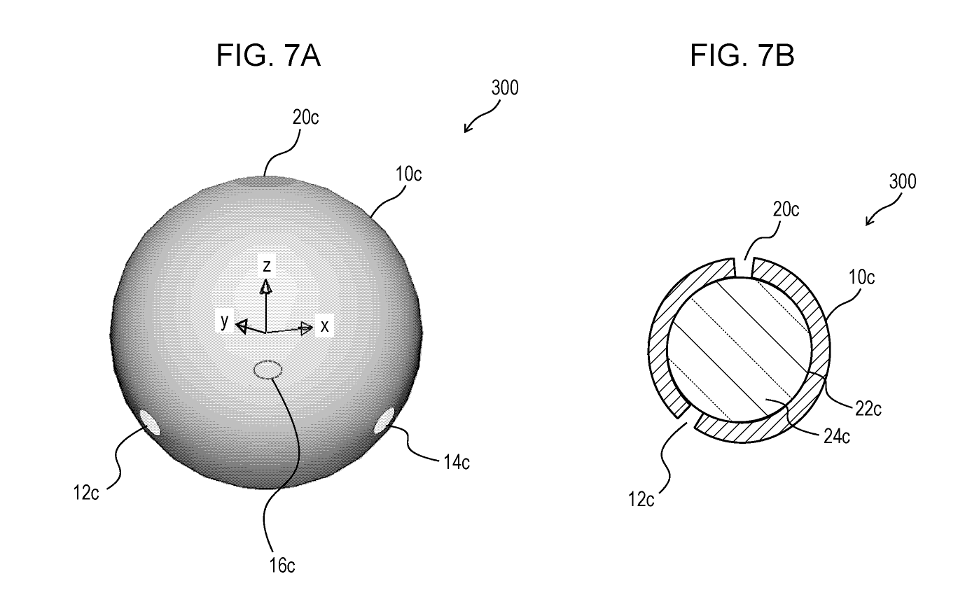

FIG. 7A is a perspective view illustrating a part of the structure of a light source device 300 according to a third embodiment. FIG. 7B is a side sectional view illustrating a part of the structure of the light source device 300. As illustrated in FIGS. 7A and 7B, the light source device 300 includes an optical member 10c, and an inner space 24c is formed in the optical member 10c. Entrance openings 12c, 14c, and 16c and one exit opening 20c are formed in the optical member 10c. Laser beams from external light sources enter through the respective entrance openings, and the laser beams are scattered or reflected in the inner space 24c and emitted from the exit opening 20c. With the above structure, light beams emitted from a plurality of light sources and entered the optical member can be uniformly mixed and emitted to the outside of the optical member.

In the present embodiment, an inner wall 22c, which defines the boundary of the inner space 24c, is coated with a light reflecting material. With the above structure, laser beams emitted from a plurality of laser-beam sources are uniformly mixed, because laser beams entered the inner space travel while being reflected by the light reflecting material on the inner wall. Examples of the light reflecting material include aluminum.

In the present embodiment, the shape of the inner wall is, for example, spherical. With the above structure, light beams emitted from a plurality of light sources and entered the optical member can be uniformly mixed and emitted to the outside of the optical member.

In the present embodiment, the inner space 24c is filled with a light-transmissive material including a light scattering substance. With the above structure, laser beams emitted from a plurality of laser-beam sources and entered the optical member can be uniformly mixed, because the laser beams are scattered by the light scattering substance while travelling straightly in the inner space of the optical member. Even if the laser beams are reflected only a small number of times by the inner wall of the optical member, the laser beams are uniformly mixed, because the laser beams are scattered by the light scattering substance filling the inner space. Examples of the light scattering substance include fine particles of titanium oxide and fine particles of alumina. Examples of the light-transmissive material include a transparent resin and a transparent glass.

In the present embodiment, the positions of the three entrance openings 12c, 14c, and 16c, and the exit opening 20c are not particularly limited. However, the entrance openings and the exit opening may be formed in such a way that, when one of the entrance openings is connected by a straight line with the center of the inner wall, any of the other entrance openings and the exit opening is located so as to avoid an extension line of the straight line. In other words, the entrance openings and the exit opening may be formed in such a way that, when one of the entrance openings is connected by a straight line with the center of the spherical inner wall, any of the other entrance openings and the exit opening does not overlap an extension line of the straight line.

With the above structure, leakage of a laser beam entered from an entrance opening to the outside of the optical member from another entrance opening or the exit opening is suppressed.

The exit opening may be formed at a position from which a laser beam that has been at least once reflected by the inner wall of the optical member is emitted to the outside. With the above structure, laser beams emitted from a plurality of light sources can be uniformly mixed and emitted to the outside of the optical member.

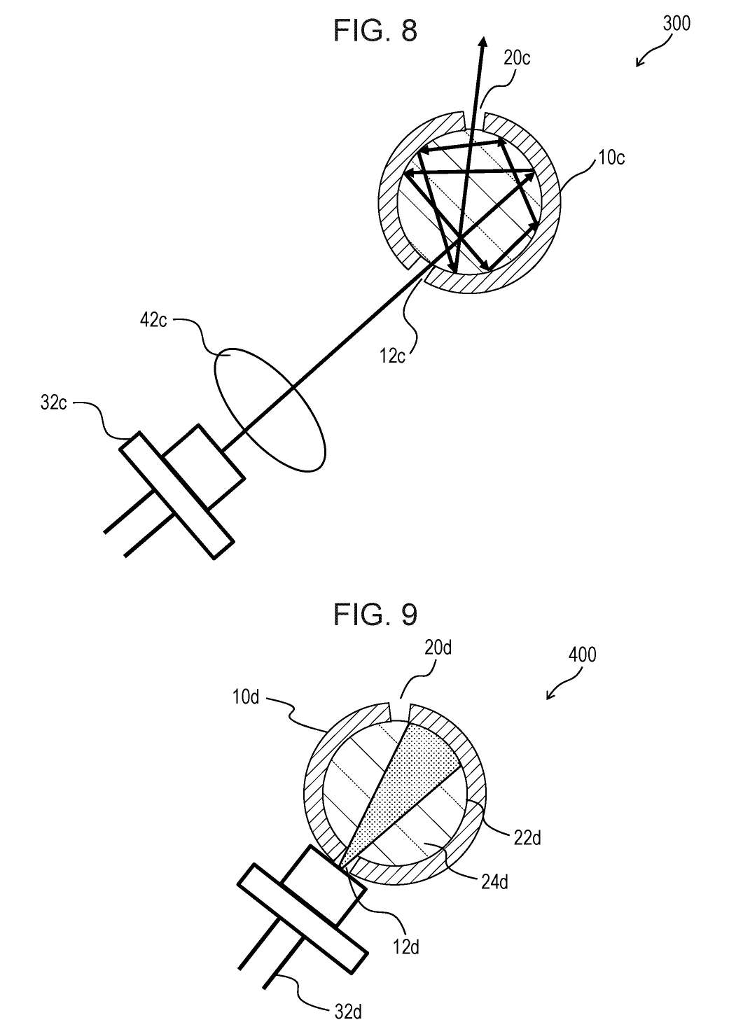

FIG. 8 is a side sectional view illustrating a part of the structure of the light source device 300 according to the present embodiment, a laser device, and the path of a laser beam. As illustrated in FIG. 8, in the present embodiment, the light source device 300 includes a collimating lens 42c. The operational effect of the collimating lens is the same as that of the first embodiment. Light sources used in the present embodiment are the same as those of the first embodiment.

Although FIG. 8 illustrates only one semiconductor laser device 32c, as an example of the present embodiment, two semiconductor laser devices that emit light beams having different wavelengths are used in addition to the semiconductor laser device 32c, and the laser beams enter through respective entrance openings. Laser beams emitted from the semiconductor lasers pass through the collimating lenses, enter the optical member 10c through the entrance openings, and mixed with each other while being diffused by diffusion particles in the optical member and repeating reflection at the inner wall. A white light beam, in which R, G, and B light beams are uniformly mixed, is emitted from the exit opening 20c.

### Fourth Embodiment

FIG. 9 is a side sectional view illustrating a part of the structure of a light source device 400 according to a fourth embodiment. As illustrated in FIG. 9, the light source device 400 includes an optical member 10d, and an inner space 24d is formed in the optical member 10d. An entrance opening 12d, two entrance openings (not shown) other than the entrance opening 12d, and one exit opening 20d are formed in the optical member 10d. Laser beams enter through the respective entrance openings, and the laser beams are scattered or reflected in the inner space 24d and emitted from the exit opening 20d. With the above structure, light beams emitted from a plurality of light sources and entered the optical member can be uniformly mixed and emitted to the outside of the optical member.

In the present embodiment, the structures and the operational effects of an inner wall 22d and the inner space 24d are the same as those of the third embodiment.

In the present embodiment, the structure in which each of R, G, and B semiconductor laser devices is disposed at a corresponding one of the entrance openings of the light source device 400 and the operational effect of the structure are the same as those of the second embodiment.

In the present embodiment, the light source device 400 does not have a lens between the laser device and the entrance opening, and the laser device is in contact with the entrance opening. With the above structure, a laser beam enters the optical member while spreading at a fixed angle and is diffused in the optical member. Therefore, even when a plurality of laser beams having different wavelengths are reflected only a small number of times by the inner wall of the optical member, the laser beams can be easily mixed.

### Fifth Embodiment

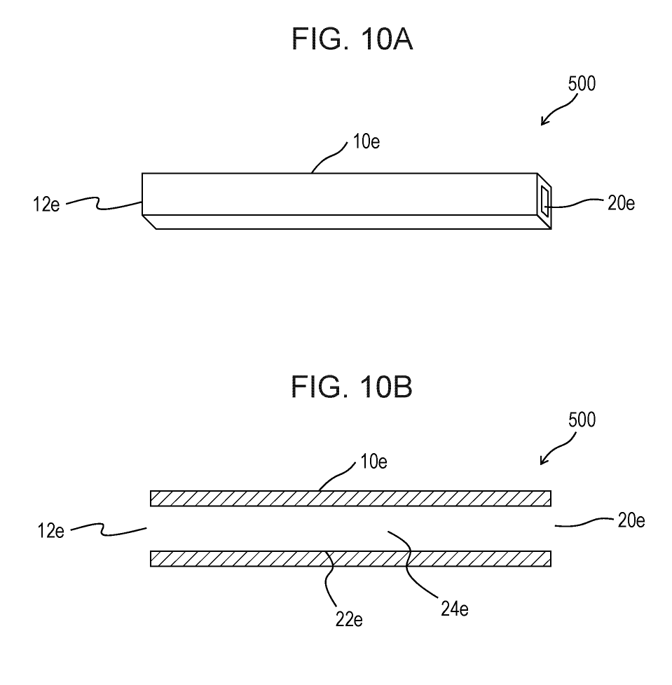

FIG. 10A is a perspective view illustrating a part of the structure of a light source device 500 according to a fifth embodiment. FIG. 10B is a side sectional view illustrating a part of the structure of the light source device 500. As illustrated in FIGS. 10A and 10B, the light source device 500 includes an optical member 10e, and an inner space 24e is formed in the optical member 10e. An entrance opening 12e and an exit opening 20e are formed in the optical member 10e. Laser beams from external light sources enter through the entrance opening 12e, and the laser beams are scattered or reflected in the inner space 24e and emitted from the exit opening 20e. With the above structure, light beams emitted from a plurality of light sources and entered the optical member can be uniformly mixed and emitted to the outside of the optical member.

In the present embodiment, an inner wall 22e, which defines the boundary of the inner space 24e, is coated with a light reflecting material, as in the third embodiment. With the above structure, laser beams emitted from a plurality of laser-beam sources are uniformly mixed, because laser beams entered the inner space travel while being reflected by the light reflecting material on the inner wall.

In the present embodiment, the inner space 24e is not filled with anything and is hollow. With the above structure, because light beams entered the optical member are not absorbed by a filler in the optical member, the light beams can be efficiently emitted to the outside of the optical member.

The shape of the inner wall 22e is a prismatic tube. The entrance opening 12e is formed at one end of the prismatic tube, and the exit opening 20e is formed at the other end of the prismatic tube. With the above structure, the light source device has high portability, because the structure of the optical member is simplified and the size of the optical member is reduced.

As an example of the present embodiment, R, G, and B laser beams emitted from three laser-beam sources, which are external light sources, enter through the entrance opening 12e, and a white light beam, which is a mixture of the R, G, and B laser beams, is emitted from one exit opening 20e. In the present embodiment, the sizes of the entrance opening and the exit opening are not particularly limited, provided that these openings allow entry and emission of laser beams. The sizes of the entrance opening and the exit opening may be appropriately determined in accordance with the areas of light emitting points of the laser-beam sources, the area to be irradiated with laser beams emitted from the exit opening, and the like. In view of uniformly mixing a plurality of laser beams having different wavelengths, the length of each side of the entrance opening and the exit opening may be in the range of 0.5 mm to 2 mm. In this case, each laser beam enters the entrance opening at an angle with respect to the incident surface of the entrance opening, and the number of times the laser beams are reflected by the inner wall of the optical member can be increased.

In the present embodiment, the length of the optical member, that is, the distance from the entrance opening to the exit opening, is not particularly limited. However, in view of uniformly mixing a plurality of laser beams having different wavelengths, the length may be 5 mm or greater, or may be 15 mm or greater. In this case, the number of times laser beams are reflected by the inner wall of the optical member can be increased.

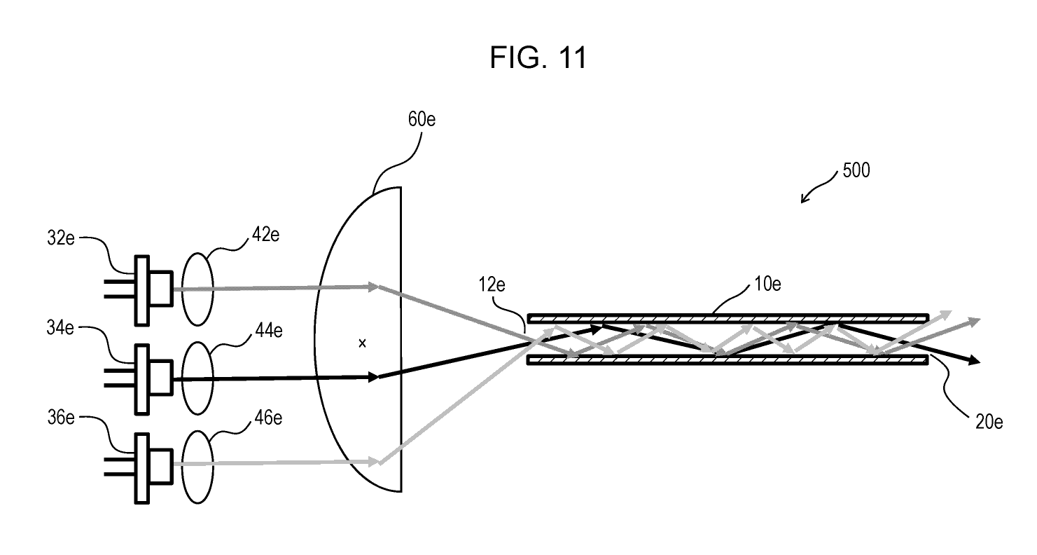

FIG. 11 is a side sectional view illustrating a part of the structure of the light source device 500, laser devices, and the paths of laser beams. As illustrated in FIG. 11, in the present embodiment, the light source device 500 includes collimating lenses 42e, 44e, and 46e. The structure and the operational effect of each of the collimating lenses are the same as those of the first embodiment.

In the present embodiment, the light source device 500 further includes a focusing portion 60e between the collimating lenses and the entrance opening 12e of the optical member. With the above structure, laser beams emitted from a plurality of laser-beam sources can be focused on the entrance opening, and the laser beams entered the optical member can be uniformly mixed and emitted to the outside. Examples of the focusing portion include a focusing lens. As an example of the present embodiment, the position of the focusing lens may be appropriately adjusted so that laser beams pass through positions in the focusing lens that are not the center of the focusing lens. With the above structure, the laser beams each enter the optical member, which is located at the focal position of the focusing lens, at an angle. Therefore, the laser beams reach the exit opening after being reflected at least once by the inner wall of the optical member, and the laser beams are uniformly mixed.

R, G, and B laser beams may enter the optical member at different incident angles with respect to the incident surface of the entrance opening. With the above structure, laser beams having different wavelengths are reflected different number of times in the optical member, and the laser beams are uniformly mixed.

As in the first embodiment, the light source device 500 may further include a light projecting portion that is disposed adjacent to the exit opening of the optical member and that controls an emitted laser beam. With the above structure, light beams emitted from a plurality of light sources and entered the optical member can be uniformly mixed and emitted to the outside of the optical member, and the area to be irradiated with light beams emitted from the exit opening can be adjusted. For example, by using a convex lens as the light projecting portion, the emitted laser beam can be controlled to be changed into a collimated beam or a converging beam.

### Modification

Referring to FIGS. 10 and 11, a modification of the light source device 500 according to the present embodiment will be described. For convenience of description, descriptions of members that have the same functions as the members of the fifth embodiment, which are illustrated in the figures, will be omitted.

The light source device 500 according to the present modification has the same structure as the fifth embodiment except that the inner wall 22e of the optical member 10e is coated with a light diffusing substance. Since the inner wall 22e is coated with a light diffusing substance, laser beams entered from the entrance opening 12e travel while being diffused and reflected by the inner wall 22e of the optical member. Because the laser beams entered the optical member are diffused and reflected, even if the length of the optical member having a prismatic tubular shape, that is, the distance from the entrance opening 12e to the exit opening 20e is small, the laser beams are uniformly mixed efficiently. In the present modification, the length of the optical member may be in the range of 5 to 15 mm.

In the present modification, the light source device 500 may include a polarizing filter or the like at the entrance opening 12e, as in the first embodiment. With the above structure, leakage of light beams, which have been diffused and reflected in the optical member, to the outside through the entrance opening 12e can be suppressed.

### Sixth Embodiment

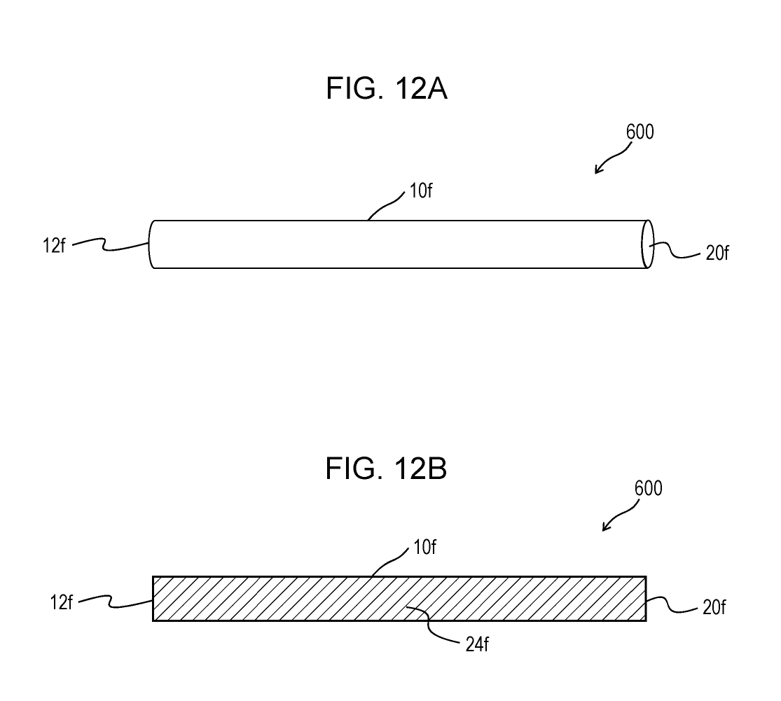

FIG. 12A is a perspective view illustrating a part of the structure of a light source device 600 according to a sixth embodiment. FIG. 12B is a side sectional view illustrating a part of the structure of the light source device 600. As illustrated in FIGS. 12A and 12B, the light source device 600 includes an optical member 10f, which is a cylindrical glass bar. An inner space 24f is formed in the optical member 10f. An entrance opening 12f and an exit opening 20f are formed in the optical member 10f. Laser beams from external light sources enter through the entrance opening 12f, and the laser beams are scattered or reflected in the inner space 24f and emitted from the exit opening 20f. With the above structure, laser beams emitted from a plurality of light sources and entered the optical member can be uniformly mixed and emitted to the outside of the optical member.

In the present embodiment, the inner space 24f is defined by the surface of a cylindrical glass bar. To be more specific, a portion the glass bar other than the boundary corresponds to the inner space 24f. As viewed from the inside of the glass bar, the surface of the glass bar, that is, the boundary between the glass bar and the outside of the glass bar corresponds to the inner wall in the embodiment described above.

The present embodiment has the same structure as the fifth embodiment except that the optical member 10f is a cylindrical glass bar. With the above structure, light beams entered the inner space travel in the inner space while being totally internally reflected, and the light beams are uniformly mixed.

The shape of the optical member 10f is a cylinder. The entrance opening 12f is formed at one end of the cylinder, and the exit opening 20f is formed at the other end of the cylinder. With the above structure, the light source device has high portability, because the structure of the optical member is simplified and the size of the optical member is reduced.

In the present embodiment, R, G, and B laser beams emitted from three laser-beam sources, which are external light sources, enter through the entrance opening 12f, and a white light beam, which is a mixture of the R, G, and B laser beams, is emitted from one exit opening 20f.

The sizes of the entrance opening and the exit opening are not particularly limited, provided that these openings allow entry and emission of laser beams. The sizes of the entrance opening and the exit opening may be appropriately determined in accordance with the areas of light emitting points of the laser-beam sources, the area to be irradiated with laser beams emitted from the exit opening, and the like. In view of uniformly mixing a plurality of laser beams having different wavelengths, the length of each side of the entrance opening and the exit opening may be in the range of 0.5 mm to 2 mm.

In the present embodiment, the length of the optical member, that is, the distance from the entrance opening to the exit opening, is not particularly limited. However, in view of uniformly mixing a plurality of laser beams having different wavelengths, the length may be 5 mm or greater, or may be 20 mm or greater. In this case, the number of times laser beams are reflected by the inner wall of the optical member can be increased.

In the present embodiment, the incident angle of a laser beam with respect to the incident surface of the entrance opening 12f may be smaller than the critical angle of total internal reflection at the interface between glass and air in the optical member. This is because reflection of a laser beam in the optical member occurs due to total internal reflection at the interface between glass and air. In the present embodiment, the optical member is filled with glass. However, provided that a laser beam can be totally internally reflected in the optical member, the optical member may be filled with a material that is not glass, such as a resin that has high light transmissivity.

In the present embodiment, the entrance opening and the exit opening each may have an antireflection coating. With the above structure, reflection of a laser beam at the entrance opening can be minimized, and the laser beam can efficiently enter the optical member. Moreover, reflection of a laser beam at the exit opening is minimized, and the laser beam can be efficiently emitted to the outside of the optical member.

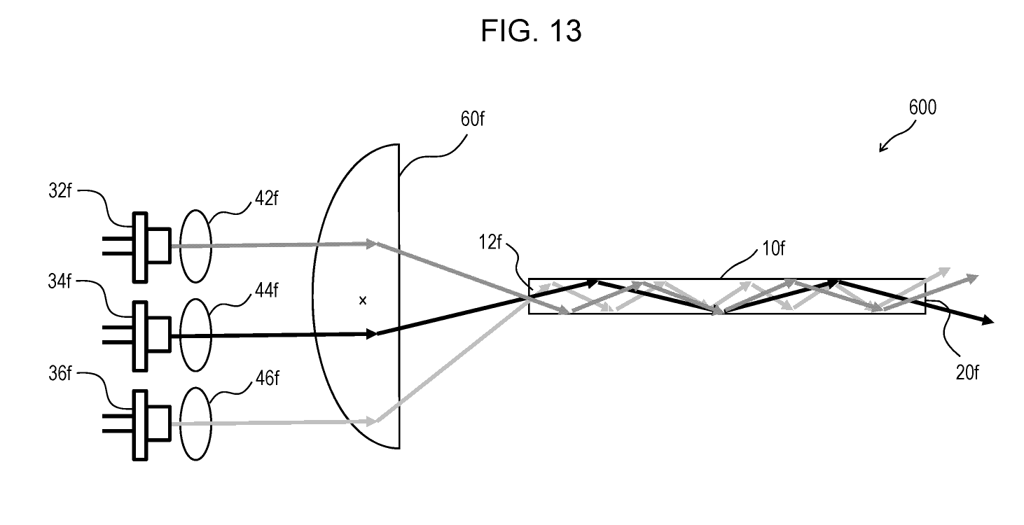

FIG. 13 is a side sectional view illustrating a part of the structure of the light source device 600 according to the present embodiment, laser devices, and the paths of laser beams. As illustrated in FIG. 13, in the present embodiment, the light source device 600 includes collimating lenses 42f, 44f, and 46f. The structure and the operational effect of each of the collimating lenses are the same as those of the first embodiment.

In the present embodiment, the light source device 600 further includes a focusing portion 60f between the collimating lenses and the entrance opening 12f of the optical member. The operational effect of the focusing portion 60f is the same as that of the focusing portion 60e of the fifth embodiment.

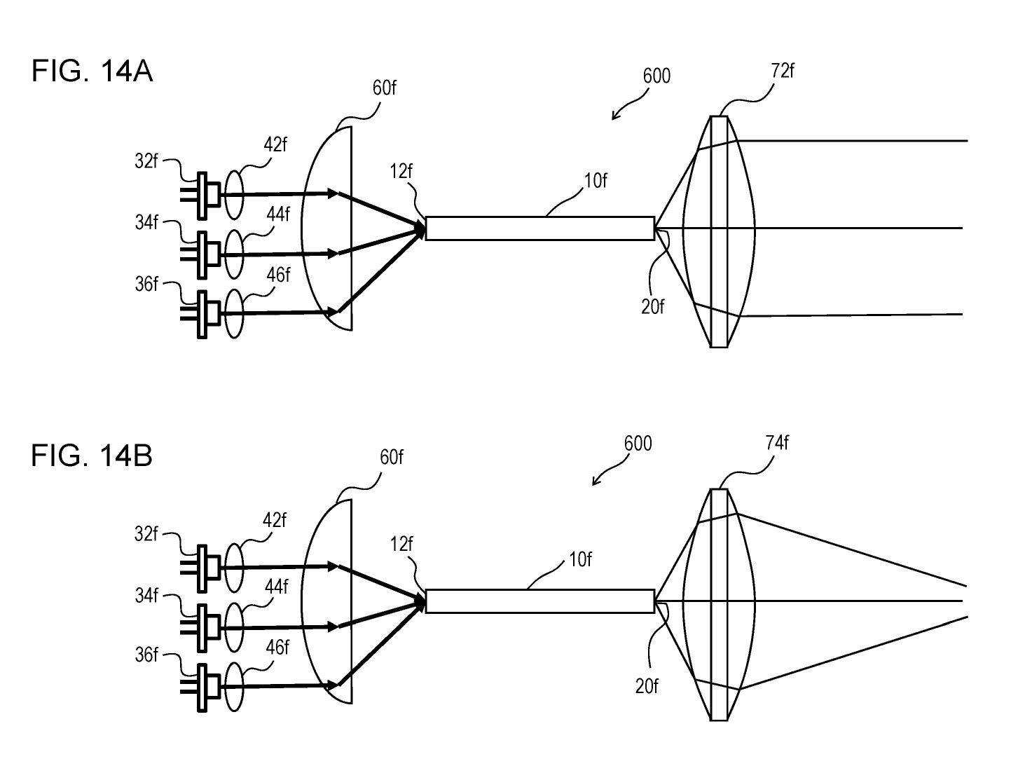

FIGS. 14A and 14B are side sectional views each illustrating a part of the structure of the light source device 600 according to the present embodiment, laser devices, and the paths of laser beams. As illustrated in FIGS. 14A and 14B, as an example of the present embodiment, the light source device 600 further includes a light projecting portion 72f or a light projecting portion 74f that is disposed adjacent to the exit opening of the optical member and that controls an emitted laser beam. The operational effect of the light projecting portion is the same as that of the first embodiment.

### Seventh Embodiment

An illumination apparatus according to a seventh embodiment includes the light source device according to any one of the first to sixth embodiments. In the present embodiment, the types and the wavelengths of semiconductor lasers and optical members that are used for the light source device may be appropriately selected in accordance with the use of the illumination apparatus. The illumination apparatus, which includes the light source device according to one of the embodiments, can be used as a headlight, plant factory illumination, an outdoor security light, a streetlight, billboard illumination, and the like. The illumination apparatus according to the present embodiment can uniformly mix light beams emitted from a plurality of light sources and can emit the light beams. Therefore, for example, the illumination apparatus can uniformly mix a visible light beam with an infrared light beam and can emit a mixed light beam. Thus, the illumination apparatus can perform infrared sensing while being used for illumination.

### Eighth Embodiment

A projector apparatus according to an eighth embodiment includes a light source device according to any one of the first to sixth embodiments. In the present embodiment, the types and the wavelengths of semiconductor lasers and optical members that are used for the light source device may be appropriately selected in accordance with the use of the projector apparatus. The projector apparatus, which includes the light source device according to one of the embodiments, can be used for digital cinema, projection mapping, digital signage, and the like. The projector apparatus according to the present embodiment can uniformly mix light beams emitted from a plurality of light sources and can emit the light beams. Therefore, for example, the projector apparatus can uniformly mix a visible light beam with an infrared light beam and can emit a mixed light beam. Thus, the projector apparatus can perform infrared sensing while performing projection of an image by using visible light.

### SUMMARY

A light source device (100, 200, 300, 400, 500, 600) according to a first aspect of the present disclosure includes an optical member (10, 10b, 10c, 10d, 10e, 10f). The optical member has an inner space (24, 24b, 24c, 24d, 24e, 24f). At least one entrance opening (12, 12b, 12c, 12d, 12e, 12f, 14, 14b, 16, 16b) and one exit opening (20, 20b, 20c, 20d, 20e, 20f) are formed in the optical member. The at least one entrance opening allows a laser beam emitted from a laser-beam source to enter the inner space. The one exit opening allows a laser beam that is scattered or reflected in the inner space to be emitted to the outside of the optical member.

With the above structure, light beams emitted from a plurality of light sources and entered the optical member can be uniformly mixed and emitted to the outside of the optical member.

A light source device (100, 200, 300, 400, 500) according to a second aspect of the present disclosure is the light source device according to the first aspect, in which the inner space is surrounded by an inner wall (22, 22b, 22c, 22d, 22e), and the inner wall is coated with a light diffusing substance or a light reflecting material.

With the above structure, light beams emitted from a plurality of light sources and entered the optical member can be uniformly mixed and emitted to the outside of the optical member, because the laser beams are diffused and reflected by the inner wall.

A light source device (300, 400) according to a third aspect of the present disclosure is the light source device according to the second aspect, in which the inner space is filled with a light-transmissive material including a light scattering substance.

With the above structure, light beams emitted from a plurality of light sources and entered the optical member can be uniformly mixed and emitted to the outside of the optical member, because the laser beams are scattered by the light scattering substance.

A light source device (100, 200) according to a fourth aspect of the present disclosure is the light source device according to the second or third aspect, in which the shape of the inner wall is hemispherical.

With the above structure, light emitted from a plurality of light sources and entered the optical member can be uniformly mixed and emitted to the outside of the optical member.

A light source device (100, 200) according to a fifth aspect of the present disclosure is the light source device according to the fourth aspect, in which the at least one entrance opening includes two or more entrance openings; and the entrance openings and the exit opening are formed in such a way that, when one of the entrance openings is connected by a straight line with the center of the circle of a bottom surface of the hemispherical inner wall, any of the other entrance openings and the exit opening does not overlap an extension line of the straight line.

With the above structure, leakage of a laser beam entered from an entrance opening to the outside of the optical member from another entrance opening or the exit opening can be suppressed.

A light source device (300, 400) according to a sixth aspect of the present disclosure is the light source device according to the second or third aspect, in which the shape of the inner wall is spherical.

With the above structure, light beams emitted from a plurality of light sources and entered the optical member can be uniformly mixed and emitted to the outside.

A light source device (300, 400) according to a seventh aspect of the present disclosure is the light source device according to the sixth aspect, in which the at least one entrance opening includes two or more entrance openings; and the entrance openings and the exit opening are formed in such a way that, when one of the entrance openings is connected by a straight line with the center of the spherical inner wall, any of the other entrance openings and the exit opening does not overlap an extension line of the straight line.

With the above structure, leakage of a laser beam entered from an entrance opening to the outside of the optical member from another entrance opening or the exit opening is prevented.

A light source device (500, 600) according to an eighth aspect of the present disclosure is the light source device according to the second or third aspect, in which the shape of the inner wall is a cylindrical tube or a prismatic tube, and the entrance opening is formed at one end of the cylindrical tube or the prismatic tube, and the exit opening is formed at the other end of the cylindrical tube or the prismatic tube.

With the above structure, the light source device has high portability, because the structure of the optical member is simplified the size of the optical member is reduced; and the light source device can mix light beams emitted from a plurality of light sources with a simple structure.

A light source device (100, 200, 300, 400) according to a ninth aspect of the present disclosure is the light source device according to any one of the first to eighth aspects, in which the at least one entrance opening includes three entrance openings, and the three entrance openings respectively allow R, G, and B laser beams to enter the inner space.

With the above structure, a white light beam in which R, G, and B laser beams are uniformly mixed can be obtained.

A light source device (100, 200, 300, 400, 500, 600) according to a tenth aspect of the present disclosure is the light source device according to the ninth aspect, further including three semiconductor laser devices that respectively emit R, G, and B light beams as the laser beam sources.

With the above structure, a white light beam in which R, G, and B laser beams are uniformly mixed can be obtained.

A light source device (100, 200, 300, 400, 500, 600) according to an eleventh aspect of the present disclosure is the light source device according to any one of the first to tenth aspects, further including a light projecting portion (72, 74, 72f, 74f) disposed outside the exit opening.

With the above structure, light beams emitted from a plurality of light sources and entered the optical member can be uniformly mixed and emitted to the outside of the optical member, and the area to be irradiated with light beams emitted from the exit opening can be adjusted.

A light source device (500, 600) according to a twelfth aspect of the present disclosure is the light source device according to any one of the first to eleventh aspects, further including a focusing portion (60e, 60f) disposed between the entrance opening and the laser-beam source.

With the above structure, laser beams emitted from a plurality of laser-beam sources can be focused on the entrance opening, and the laser beams entered the optical member can be uniformly mixed and emitted to the outside.

An illumination apparatus according to a thirteenth aspect of the present disclosure includes the light source device according to any one of the first to twelfth aspects.

With the above structure, light in which laser beams emitted from a plurality of laser-beam sources are uniformly mixed can be used for illumination. The illumination apparatus can uniformly mix light beams having different wavelengths, such as a visible light beam and an infrared light beam, and can emit a mixed light beam. Therefore, the illumination apparatus can perform infrared sensing while being used for illumination.

A projector apparatus according to a fourteenth aspect of the present disclosure includes the light source device according to any one of the first to twelfth aspects.

With the above structure, light in which laser beams emitted from a plurality of laser-beam sources are uniformly mixed can be used for image projection. The projector apparatus can uniformly mix light beams having different wavelengths, such as a visible light beam and an infrared light beam, and can emit a mixed light beam. Therefore, the projector apparatus can perform infrared sensing while being used for illumination.

The present disclosure is not limited to the embodiments described above and can be modified in various ways within the scope of the present disclosure described in the claims. The technical scope of the present disclosure includes embodiments that can be obtained by using appropriate combinations of technical elements disclosed in different embodiments. Moreover, new technical features can be formed by using combinations of technical elements disclosed in the embodiments.

The present disclosure contains subject matter related to that disclosed in Japanese Priority Patent Application JP 2018-076973 filed in the Japan Patent Office on Apr. 12, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A light source device comprising:
an optical member,
wherein the optical member has an inner space, and
wherein at least one entrance opening and one exit opening are formed in the optical member, the at least one entrance opening allows a laser beam emitted from a laser-beam source to enter the inner space, and the one exit opening allows a laser beam that is scattered or reflected in the inner space to be emitted to the outside of the optical member.

2. The light source device according to claim 1,
wherein the inner space is surrounded by an inner wall, and
wherein the inner wall is coated with a light diffusing substance or a light reflecting material.

3. The light source device according to claim 2,
wherein the inner space is filled with a light-transmissive material including a light scattering substance.

4. The light source device according to claim 2,
wherein a shape of the inner wall is hemispherical.

5. The light source device according to claim 4,
wherein the at least one entrance opening includes two or more entrance openings, and
wherein the entrance openings and the exit opening are formed in such a way that, when one of the entrance openings is connected by a straight line with a center of a circle of a bottom surface of the hemispherical inner wall, any of the other entrance openings and the exit opening does not overlap an extension line of the straight line.

6. The light source device according to claim 2,
wherein a shape of the inner wall is spherical.

7. The light source device according to claim 6,
wherein the at least one entrance opening includes two or more entrance openings, and
wherein the entrance openings and the exit opening are formed in such a way that, when one of the entrance openings is connected by a straight line with a center of the spherical inner wall, any of the other entrance openings and the exit opening does not overlap an extension line of the straight line.

8. The light source device according to claim 2,
wherein a shape of the inner wall is a cylindrical tube or a prismatic tube, and
wherein the entrance opening is formed at one end of the cylindrical tube or the prismatic tube, and the exit opening is formed at the other end of the cylindrical tube or the prismatic tube.

9. The light source device according to claim 1,
wherein the at least one entrance opening includes three entrance openings, and
wherein the three entrance openings respectively allow light beams emitted from R, G, and B laser-beam sources to enter the inner space.

10. The light source device according to claim 9, further comprising:
three semiconductor laser devices that respectively emit R, G, and B light beams as the laser beam sources.

11. The light source device according to claim 1, further comprising:
a light projecting portion disposed outside the exit opening.

12. The light source device according to claim 1, further comprising:
a focusing portion disposed between the entrance opening and the laser-beam source.

13. An illumination apparatus comprising:
the light source device according to claim 1.

14. A projector apparatus comprising:
the light source device according to claim 1.
